(19) United States
(12) Patent Application Publication
(10) Pub. No.: US 2024/0006683 A1
(43) Pub. Date: Jan. 4, 2024

(54) BATTERY MODULE AND BATTERY PACK INCLUDING THE SAME

(71) Applicant: LG ENERGY SOLUTION, LTD., Seoul (KR)

(72) Inventors: Min Seop KIM, Daejeon (KR); Junyeob SEONG, Daejeon (KR); Jongpil JEON, Daejeon (KR)

(21) Appl. No.: 18/038,965

(22) PCT Filed: Aug. 30, 2022
(86) PCT No.: PCT/KR2022/012935

§ 371 Date: May 25, 2023

(30) Foreign Application Priority Data
Sep. 2, 2021 (KR) 10-2021-0116870

(51) Int. Cl. H01M 10/6567; H01M 50/507

(52) U.S. Cl. CPC H01M 10/6567; H01M 50/507; H01M 10/613

(57) ABSTRACT

A battery module including a battery cell stack in which a plurality of battery cells are stacked, a housing that surrounds the battery cell stack, and a pair of end plates that cover the exposed front and rear surfaces of the battery cell stack, respectively, and the battery module comprises a heat transfer member formed in a space between the battery cell stack and each of the pair of end plates.

### CROSS-REFERENCE TO RELATED APPLICATIONS

This application is a US national phase of international application No. PCT/KR2022/012935 filed on Aug. 30, 2022, and claims the benefit of Korean Patent Application No. 10-2021-0116870 filed on Sep. 2, 2021, the entire contents of which are incorporated herein by reference.

### TECHNICAL FIELD

The present disclosure relates to a battery module and a battery pack including the same, and more particularly to a battery module having a novel cooling structure and a battery pack including the same.

### BACKGROUND

Along with developments in technology and increased demand for mobile devices, the demand for batteries as energy sources is increasing rapidly. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Small-sized mobile devices use one or several battery cells for each device, whereas medium- or large-sized devices such as vehicles require high power and large capacity. Therefore, a medium- or large-sized battery module having a plurality of battery cells electrically connected to one another is used.

The medium- or large-sized battery module is preferably manufactured to have as small a size and weight as possible. Consequently, a prismatic battery, a pouch-shaped battery or the like, which can be stacked with high integration and has a small weight relative to capacity, is mainly used as a battery cell of the medium- or large-sized battery module. Such a battery module has a structure in which a plurality of cell assemblies including a plurality of unit battery cells are connected in series to obtain high output. The battery cell includes positive electrode and negative electrode current collectors, a separator, an active material, an electrolyte, and the like, and thus can be repeatedly charged and discharged through an electrochemical reaction between components.

In recent years, as the need for large-capacity structures including their utilization as an energy storage source is growing, there is an increasing demand for battery packs having a multi-module structure formed by assembling a plurality of battery modules in which a plurality of secondary batteries are connected in series and/or in parallel.

Further, when a plurality of battery cells are connected in series or in parallel to configure a battery pack, it is common to manufacture a battery module and configure a battery pack including the at least one battery module composed of at least one battery cell, by adding other components.

When the temperature of the secondary battery rises higher than an appropriate temperature, the performance of the secondary battery may deteriorate, and in the worst case, there is also a risk of an explosion or ignition. In particular, when a large number of secondary batteries are used, that is, a battery module or a battery pack having a plurality of battery cells, heat generated from the large number of battery cells in a narrow space can add up, and the temperature can rise more quickly and excessively. In other words, high output can be obtained from a battery module in which a large number of battery cells are stacked, and a battery pack equipped with such a battery module, but it is not easy to remove heat generated from the battery cells during charging and discharging. When the heat is not dissipated property from the battery cell, deterioration of the battery cells is accelerated, the lifespan is shortened, and the possibility of explosion or ignition increases.

Moreover, in the case of a medium- or large-sized battery module included in a vehicle battery pack, it is frequently exposed to direct sunlight and may be placed under high-temperature conditions such as in the summer or in desert areas.

FIG. 1 is a cross-sectional view of a conventional battery module.

Referring to FIG. 1, the conventional battery module 10 includes a battery cell stack 20 in which a plurality of battery cells 11 are stacked, and a housing 30 that houses the battery cell stack 20. A thermal conductive resin layer 40 may be located between the lower part of the battery cell stack 20 and the bottom part 31 of the housing 30.

The conventional battery module allows heat generated in the battery cells 11 to be released only through a one-way path passing though the thermal conductive resin layer 40 formed under the battery cell stack 20 and the bottom part 31 of the housing 30.

However, in recent years, the need for high capacity, high energy, fast charging, and the like is continuously increasing, and the amount of current flowing through the busbar is increasing and heat generated from the busbar, the battery cell, and the electrode lead tends to increase. Such heat generation is hard to effectively cool through a conventional cooling structure alone. Therefore, there is a need for a novel structure that can be in direct contact with the battery cell and busbar and enables rapid cooling to dissipate the generated heat.

### SUMMARY

It is an objective of the present disclosure to provide a battery module that can solve the heat generation problem of a battery cell and a busbar, and a battery pack including the same.

However, the objectives of the present disclosure are not limited to the aforementioned objectives, and other objectives which are not mentioned herein should be clearly understood by those skilled in the art from the following detailed description and the accompanying drawings.

According to one embodiment of the present disclosure, there is provided a battery module comprising: a battery cell stack in which a plurality of battery cells are stacked, a housing that surrounds the battery cell stack, and a pair of end plates that cover the exposed front and rear surfaces of the battery cell stack, wherein the battery module comprises a heat transfer member formed in a space between the battery cell stack and each of the pair of end plates.

The battery module further comprises a pair of busbar frames, each of which is formed between the front and rear surfaces of the battery cell stack and the respective end plate, wherein the heat transfer member may be formed in a space between the battery cell stack and the respective busbar frame, and a space between each of the busbar frames and the respective end plate.

The heat transfer member may wholly fill a space between the battery cell stack and each of the busbar frames and a space between each of the busbar frames and the respective end plate.

The battery module further comprises an electrode lead protruding from the battery cell stack, wherein the heat transfer member may be in contact with the electrode lead.

The battery module comprises a plurality of busbars mounted on each of the busbar frames, wherein the heat transfer member may be in contact with the plurality of busbars and the pair of busbar frames.

The housing comprises a frame member covering the lower surface and both side surfaces of the battery cell stack, and an upper plate covering an upper surface of the battery cell stack, and the heat transfer member may be in contact with the bottom part of the frame member and the upper plate.

The heat transfer member is made of a flowable material, and the heat transfer member may be movable.

The heat transfer member may be in the form of a gel.

The busbar frame of the battery module according to another embodiment of the present disclosure may comprise a plurality of prevention parts protruding inwards from an end plate.

The busbar frame further comprises a groove, and the adjacent prevention parts may be spaced apart from each other by the groove.

The heat transfer member may be formed at a lower end of the prevention part to be in contact with the prevention part.

The prevention part may prevent the heat transfer member from flowing out to the upper part of the prevention part.

According to yet another embodiment of the present disclosure, there can be provided a battery pack comprising the above-mentioned battery module.

The battery module according to one embodiment of the present disclosure includes a heat transfer member, thereby capable of solving the heat generation problem of battery cells and busbars in high current and fast charging environments. The stability of the battery module may also be improved by solving the heat generation problem.

In addition, the heat transfer member fills a space between the battery cell stack and each of the busbar frames, and a space between each of the busbar frames and the respective end plate, thereby improving the insulating performance of the battery module.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a cross-sectional view of a conventional battery module;

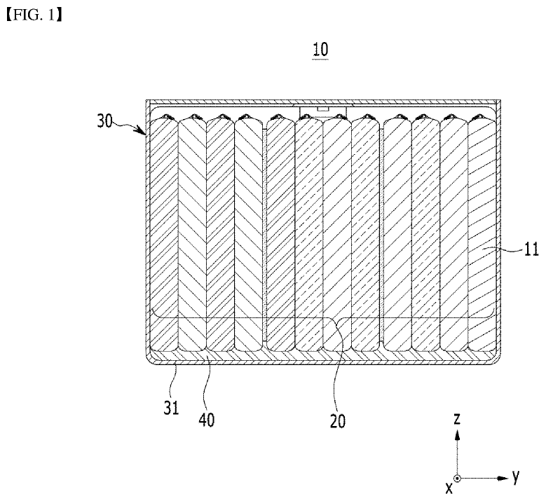

FIG. 2 is an exploded perspective view of the battery module of the present disclosure;

FIG. 3 is a perspective view of a battery module in which the components of FIG. 2 are assembled;

FIG. 4 is an enlarged cross-sectional view along section P1 of FIG. 3;

FIG. 5 is an enlarged cross-sectional view along section P2 of FIG. 3;

FIG. 6 is a perspective view of a battery cell included in the battery module of the present disclosure;

FIG. 7 is a cross-sectional view of a battery module according to another embodiment of the present disclosure; and

FIG. 8 is an illustration of a busbar frame included in a battery module according to another embodiment of the present disclosure.

### DETAILED DESCRIPTION

Hereinafter, various embodiments of the present disclosure will be described in detail with reference to the accompanying drawings so that those skilled in the art can easily carry out these embodiments. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggeratedly illustrated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

The terms “first,” “second,” etc. are used to explain various components, but the components should not be limited by the terms. These terms are only used to distinguish one component from the other component.

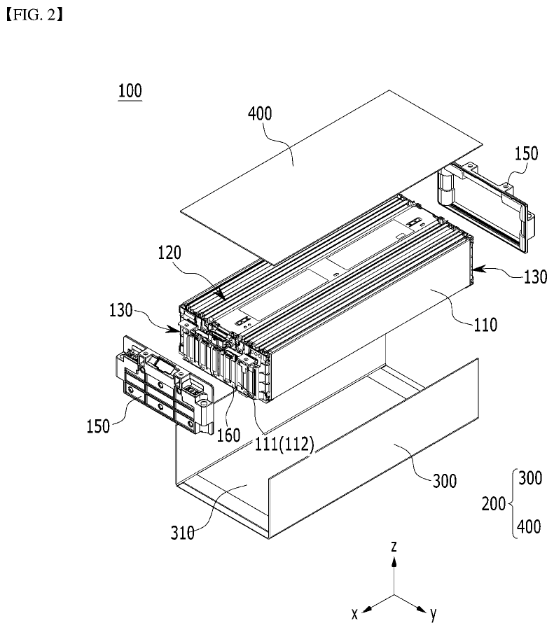

Hereinafter, a battery module according to an embodiment of the present disclosure will be described with reference to FIGS. 2 to 6.

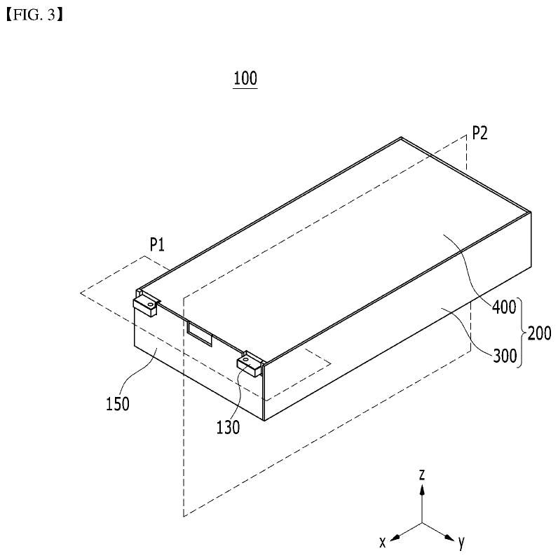

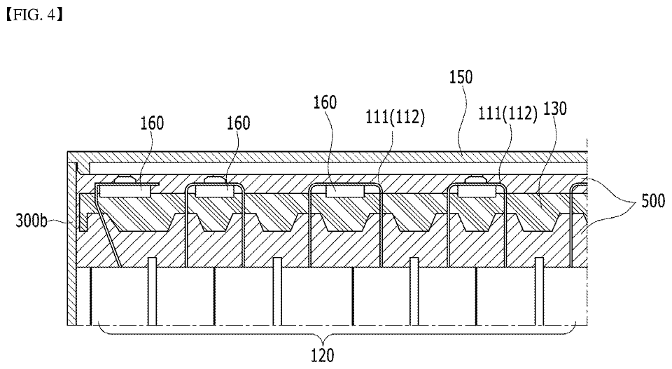

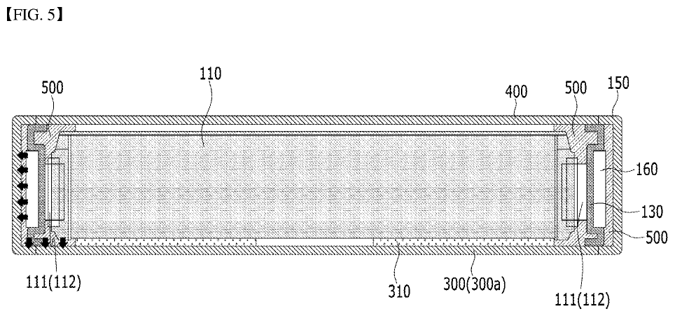

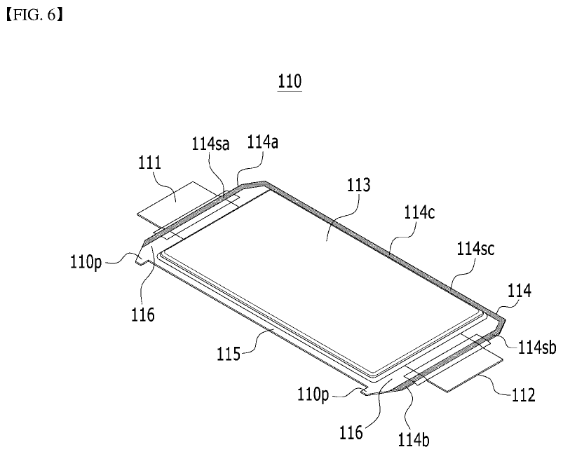

FIG. 2 is an exploded perspective view of the battery module of the present disclosure. FIG. 3 is a perspective view of a battery module in which the components of FIG. 2 are assembled. FIG. 4 is an enlarged cross-sectional view along section P1 of FIG. 3. FIG. 5 is an enlarged cross-sectional view along section P2 of FIG. 3. FIG. 6 is a perspective view of a battery cell included in the battery module of the present disclosure.

Referring to FIGS. 2 and 3, a battery module 100 according to the present embodiment includes a battery cell stack 120 in which a plurality of battery cells 110 are stacked, and a housing 200 that surrounds the battery cell stack 120.

The battery cell 110 is preferably a pouch-type battery cell, and can be formed in a rectangular sheet-like structure. For example, referring to FIG. 6, the battery cell 110 according to the present embodiment has a structure in which two electrode leads 111 and 112 face each other and protrude from one end part 114a and the other end part 114b of the cell main body 113, respectively. That is, the battery cell 110 includes electrode leads 111 and 112 that protrude in mutually opposite directions. More specifically, the electrode leads 111 and 112 are connected to an electrode assembly (not shown), and protrude from the electrode assembly (not shown) to the outside of the battery cell 110.

The battery cell 110 can be produced by joining both end parts 114a and 114b of a cell case 114 and one side part 114c connecting them in a state in which an electrode assembly (not shown) is housed in a cell case 114. In other words, the battery cell 110 according to the present embodiment has a total of three sealing parts 114sa, 114sb and 114sc, wherein the sealing parts 114sa, 114sb and 114sc is sealed by a method such as heat-sealing, and the remaining other side part may be composed of a connection part 115. The cell case 114 may be composed of a laminated sheet including a resin layer and a metal layer.

Further, the connection part 115 may extend along one long edge of the battery cell 110, and a bat ear 110p may be formed at an end of the connection part 115. Moreover, while the cell case 114 is sealed with the protruding electrode leads 111 and 112 being interposed therebetween, a terrace part 116 may be formed between the electrode leads 111 and 112 and the cell main body 113. That is, the battery cell 110 may include a terrace part 116 that extends from the cell case 114 in a protrusion direction of the electrode leads 111 and 112.

A plurality of such battery cells 110 may be formed, and the plurality of battery cells 110 can be stacked to be electrically connected to each other, thereby forming a battery cell stack 120. Particularly, as shown in FIG. 2, a plurality of battery cells 110 may be stacked along the direction parallel to the y-axis. Thereby, the electrode leads 111 and 112 may protrude in the +x-axis direction and the −x-axis direction, respectively.

Heat is generated when the battery cells 110 are repeatedly charged and discharged. Among the plurality of battery cells, a great amount of heat is generated in a portion adjacent to the electrode leads 111 and 112. That is, more heat is generated adjacent to the electrode leads 111 and 112 rather than the central portion of the cell main body 113 during the charging and discharging processes, and a structure for cooling the corresponding part may be required.

Meanwhile, the housing 200 may include a frame member 300 which is open at the upper, front and rear parts, and covers the lower surface and both side surfaces of the battery cell stack 120, and an upper plate 400 that covers an upper surface of the battery cell stack 120. However, the housing 200 is not limited thereto, and can be replaced with a frame having another shape such as an L-shaped frame or a mono-frame surrounding the battery cell stack 120 except the front and rear surfaces. The battery cell stack 120 housed inside the housing 200 can be physically protected through the housing 200. The frame member 300 may include a bottom part 300a that supports the lower surface of the battery cell stack 120, and side surface parts 300b each extending upward from both ends of the frame bottom part 300a.

The upper plate 400 may cover the exposed upper side surface of the housing 200. The pair of end plates 150 can cover the front and rear surfaces of the battery cell stack 120 that are exposed in the housing 200. Each of end plates 150 can be weld-coupled with the front and rear end edges of the upper plate 400 and the front and rear end edges of the housing 200.

A pair of busbar frames 130 can be formed between each of the end plates 150 and the respective front and rear surfaces of the battery cell stack 120. A plurality of busbars 160 mounted on each of the busbar frames 130 can protrude from the battery cells 110 to be in contact with the electrode leads 111 and 112 mounted on the respective busbar frame 130.

Further, the battery module 100 according to the present embodiment further includes a thermal conductive resin layer 310 located between the lower surface of the battery cell stack 120 and the bottom part of the housing 200, that is, the bottom part 300a of the frame member 300, and the thermal conductive resin layer 310 may transfer heat generated in the battery cells 110 to the bottom of the battery module 100 and fix the battery cell stack 120.

The conventional battery module allows heat generated in the battery cells to be released through the thermal conductive resin layer formed under the battery cell. However, the thermal conductive resin layer of the conventional battery module has a problem that it cannot efficiently cool the heat generated from the electrode leads and busbar frames on the front and rear surfaces of the battery cell, and busbars mounted to the busbar frames. Further, in the case of a conventional battery module, a space between the battery cell stack and the busbar frames and a space between the busbar frames and the respective end plates are empty, which deteriorates insulation performance due to inflow of moisture and foreign matters in the empty spaces. Therefore, in situations where the electrode leads and busbars of the battery cells generate high heat in a short period of time due to the flow of high current, such as rapid charging, there is a need for a structure that can effectively cool the heat generation.

Therefore, referring to FIGS. 4 and 5, the battery module 100 according to the present embodiment includes a heat transfer member 500 formed in a space between the battery cell stack 120 and the end plates 150. Specifically, the heat transfer member 500 may be formed in a space between the battery cell stack 120 and the respective busbar frames 130 and a space between each of the bus bar frames 130 and the respective end plate 150. Moreover, an insulating cover may be further formed in the space between the busbar frame 130 and the respective end plate 150, so that the heat transfer member 500 can fill the space between the busbar frame 130 and the insulating cover.

In particular, the heat transfer member 500 may wholly fill the above-mentioned spaces. That is, the heat transfer member 500 may wholly fill the space between the battery cell stack 120 and each of the busbar frames 130 and the space between each of the busbar frames 130 and the respective end plate 150. Therefore, through the heat transfer member 500 filling the whole of the respective spaces, the insulation performance is improved, and the possibility of penetration of moisture and foreign matters is minimized, thereby improving the stability of the battery module. When moisture or foreign mattes penetrate from the outside, a short circuit of the busbar 160 and the lifespan of the battery module 100 may be reduced. Therefore, the heat transfer member 500 prevents moisture and foreign substances from penetrating into the battery module and contacting the busbar 160 and the electrode leads 111 and 112, thereby securing the performance of the battery module and improving stability.

As described above, the heat transfer member 500 according to the present embodiment may be in contact with the electrode leads 111 and 112. The electrode leads 111 and 112, which are portions where a large amount of heat is generated in the battery cells 110, are the portions of the battery cell 110 that require the most cooling. However, there is no structure for directly contacting the electrode leads 111 and 112 to form a cooling path, which poses a problem. Thus, in the case of the battery module 100 according to the present embodiment, the heat transfer member 500 allows effective cooling of the electrode leads 111 and 112. In particular, the heat transfer member 500 may be in surface contact with the electrode leads 111 and 112, and as the contact area increases, effective cooling can be made by the contact even when a large amount of heat is generated.

Further, the heat transfer member 500 may also be in contact with the busbars 160 and the busbar frames 130. Heat generated from the busbars 160 can be cooled through the heat transfer member 500, and can be rapidly transferred through other components that are in contact with the heat transfer member 500. Further, the heat transfer member 500 is in contact with the plurality of busbars 160 formed in the battery module 100, thereby preventing physical contact between the busbars 160. Therefore, a short circuit caused by the contact between the busbars 160 can be interrupted.

In addition, the heat transfer member 500 may be in contact with the bottom part 300a and the upper plate 400 of the frame member 300. Specifically, referring to FIG. 5, the heat transfer member 500 may be in contact with the bottom part 300a of the frame member 300 and the heat conductive resin layer 310. Further, the heat transfer member 500 may be in contact with the upper plate 400. Therefore, the heat transfer member 500 is in contact with the bottom part 300a of the frame member 300, the heat conductive resin layer 310, and the upper plate 400 to thereby form additional heat transfer paths and transfer and dissipate heat to and from the outside of the battery module. The heat transfer member 500 may be in surface contact with the configuration described above. The heat transfer member 500 is formed in a shape for filling the space, thereby making surface contact with the components and achieving improved cooling efficiency.

As described above, the heat transfer member 500 according to the present embodiment may be in contact with a plurality of components. In particular, the heat transfer member 500 is in direct contact with the busbars 160 and the electrode leads 111 and 112 that generate a large amount of heat, and immediately transfers the heat generated from the busbars 160 and the electrode leads 111 and 112 through the plurality of components, thereby improving the temperature deviation between the components in the battery module, especially the parts of the battery cell.

The heat transfer member 500 may be formed of a flowable material. The heat transfer member 500 may include a heat transfer material that is injected and cured. It may contain a gel form that is not completely cured. That is, the heat transfer member 500 may be in gel form. As the heat transfer member 500 is in gel form, it is possible to secure cooling performance and at the same time have flowability, thereby coping with changes in some of the components in the battery module. Therefore, the heat transfer member 500 can be moved in a situation such as an air pocket formed in the battery module, thereby ensuring continuous cooling performance.

In addition, the heat transfer member 500 may be formed of a material having thermal conductivity and may be formed of a material having insulation properties. Therefore, it is possible to achieve the effect of improving cooling performance and insulating performance through heat transfer by including the heat transfer member 500.

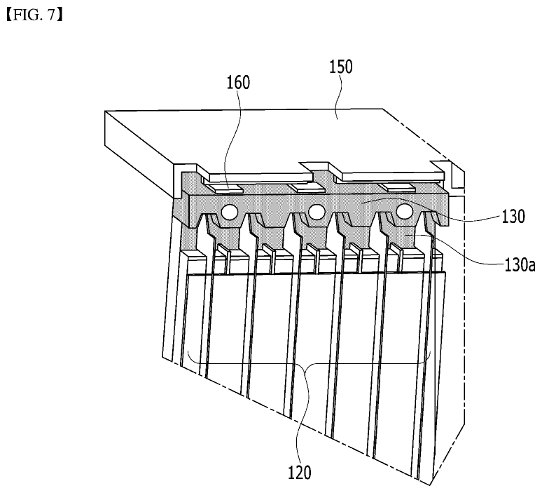

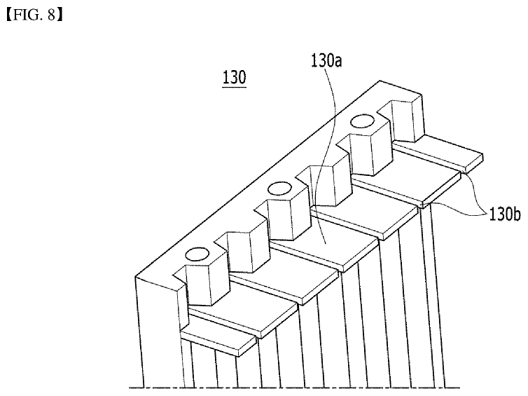

Next, a battery module according to another embodiment of the present disclosure will be described with reference to FIGS. 7 and 8. Since there are contents that overlap with those described above, only the portions different from the contents described above will be described.

FIG. 7 is a cross-sectional view of a battery module according to another embodiment of the present disclosure. FIG. 8 is a perspective view of a busbar frame included in the battery module.

Referring to FIGS. 7 and 8, the busbar frame 130 of the battery module 100 according to the present embodiment may include a plurality of prevention parts 130a protruding in a direction inwards from an end plate 150. At this time, referring to FIG. 5, the heat transfer member 500 may be formed at the lower end of the prevention parts 130a to be in contact with the prevention parts 130a.

As described above, the heat transfer member 500 is formed of a flowable material and thus is movable within the battery module. Therefore, the prevention part 130a may play a role of partially fixing a position where the heat transfer member 500, which is a flowable material, is in contact with the respective busbar 130 and the electrode leads 111 and 112. Further, the prevention parts 130a may prevent the heat transfer member 500 from leaking to the upper part of the prevention parts 130a as the heat transfer member 500 moves. Therefore, since the shape and position of the heat transfer member 500 are partially fixed, it is possible to secure and maintain a contact area with the heat generating component, thereby securing cooling performance.

Meanwhile, the busbar frames 130 may further include a plurality of grooves 130b, and the grooves 130b may be formed between adjacent prevention parts 130a. That is, the grooves 130b may be gaps formed between prevention parts 130a such that the prevention parts 130a are spaced apart from each other. Thus, the groove 130b may be used as a passage through which the terrace part 116 of each of the battery cells 110 and the electrode leads 111 and 112 pass.

Next, a battery pack according to another embodiment of the present invention will be described.

The battery pack according to the present embodiment includes the battery module described above. In addition, the battery pack of the present disclosure may have a structure in which one or more of the battery modules according to the present embodiment are gathered, and packed together with a battery management system (BMS) and a cooling device that control and manage battery's temperature, voltage, etc.

The battery pack can be applied to various devices. Such a device can be applied to a vehicle means such as an electric bicycle, an electric vehicle, or a hybrid vehicle, but the present disclosure is not limited thereto, and is applicable to various devices that can use a battery module, which also falls under the scope of the present disclosure.

Although preferred embodiments of the present disclosure have been described in detail above, the scope of the present disclosure is not limited thereto, and numerous other modifications and embodiments can be devised by those skilled in the art, without departing from the spirit and scope of the principles of the invention described in the appended claims. Further, these modifications should not be understood individually from the technical spirit or perspective of the present disclosure.

1. A battery module comprising:
a battery cell stack comprising a plurality of battery cells,
a housing surrounding the battery cell stack,
front and rear end plates that cover exposed front and rear surfaces of the battery cell stack, respectively, and
a heat transfer member formed in a space between the battery cell stack and each of the front and rear end plates.

2. The battery module according to claim 1, further comprising:
front and rear busbar frames,
wherein each of the front and rear busbar frames is formed between the front and rear surfaces of the battery cell stack and the front and rear end plates, respectively,
wherein the heat transfer member is formed in a space between the battery cell stack and the front and rear busbar frames, respectively, and a space between the front and rear busbar frames and the front and rear end plates, respectively.

3. The battery module according to claim 2 wherein:
the heat transfer member wholly fills the space between the battery cell stack and the front and rear busbar frames and the space between the front and rear busbar frames and the front and rear end plates, respectively.

4. The battery module according to claim 2, further comprising:
an electrode lead protruding from the battery cell stack,
wherein the heat transfer member is in contact with the electrode lead.

5. The battery module according to claim 4, further comprising:
a plurality of busbars mounted on each of the front and rear busbar frames,
wherein the heat transfer member is in contact with the plurality of busbars and the front and rear busbar frames.

6. The battery module according to claim 1 wherein:
the housing comprises a frame member covering a lower surface and two side surfaces of the battery cell stack, and an upper plate covering an upper surface of the battery cell stack, and
the heat transfer member is in contact with a bottom part of the frame member and the upper plate.

7. The battery module according to claim 1 wherein:
the heat transfer member comprises a flowable material, and
the heat transfer member is movable.

8. The battery module according to claim 7 wherein:
the heat transfer member is a gel.

9. The battery module according to claim 2 wherein:
each of the front and rear busbar frames comprises a plurality of prevention parts protruding in a direction inwards from the respective front and rear end plates.

10. The battery module according to claim 9 wherein:
each of the front and rear busbar frames further comprises a plurality of grooves, and
the plurality of grooves are formed between adjacent prevention parts such that adjacent prevention parts are spaced apart from each other.

11. The battery module according to claim 9 wherein:
the heat transfer member is formed at a lower end of the prevention part and is in contact with the prevention part.

12. The battery module according to claim 9 wherein:
the prevention parts prevent the heat transfer member from flowing out to an upper part of each of the prevention parts.

13. A battery pack comprising the battery module of claim 1.
